(19) United States
(12) Patent Application Publication
(10) Pub. No.: US 2013/0194968 A1
(43) Pub. Date: Aug. 1, 2013

(54) COMMUNICATION DEVICE, PROGRAM AND COMMUNICATION METHOD

(71) Applicant: Kabushiki Kaisha Toshiba, Tokyo (JP)

(72) Inventor: Masaya Masuda, Tokyo (JP)

(73) Assignee: KABUSHIKI KAISHA TOSHIBA, Tokyo (JP)

(21) Appl. No.: 13/685,400

(22) Filed: Nov. 26, 2012

(30) Foreign Application Priority Data
Jan. 30, 2012 (JP) 2012-017289

(51) Int. Cl. H04W 88/06

(52) U.S. Cl. CPC H04W 88/06
USPC 370/254

(57) ABSTRACT

At least one embodiment provides a communication device including: a communicator configured to communicate with another communication device through at least one of a first communication topology and a second communication topology; a processor configured to execute an application; a communication topology determiner configured to determine one of the first and second communication topologies based on at least a kind of the application; a software determiner configured to determine one of a first control software which supports both of the first and second communication topologies and a second control software which supports only the second communication topology, the software determiner selecting the second communication topology when the communication topology determiner determines the second communication topology; and a communication controller configured to control the communicator using the determined control software to establish the communication with the another communication device through the determined communication topology.

### CROSS-REFERENCE TO RELATED APPLICATION(S)

This application claims priority from Japanese Patent Application No. 2012-017289, filed on Jan. 30, 2012, the entire contents of which are incorporated herein by reference.

### FIELD

Embodiments described herein relate generally to a communication device, a program and a communication method.

### BACKGROUND

In recent years, various communication topologies (communication specifications) have been popularized in accordance with the development of the communication technologies. For example, there are communication topology capable of executing communication by low power consumption and a communication topology capable of performing high speed communication.

In the case where communication devices executes transmission/reception of data of a predetermined quantity, e.g., content data, etc., before the communication connection has been established (before the transmission/reception has been started), it may be suitable to use a low power consumption communication topology rather than a high speed communication topology. On the other hand, after the communication connection has been established (during the transmission/reception is performed), it may be suitable to use the high speed communication topology rather than the low power consumption communication topology.

For example, there is known Bluetooth wireless technology (trademark, which will be hereinafter simply referred to as “Bluetooth”) as a communication protocol. In the Bluetooth v.4.0, in addition to the previously-defined communication topologies such as BR (Basic Rate)/EDR (Enhanced Data Rate), etc., a communication topology of LE (Low Energy) which has low communication speed but can suppress power consumption as compared with BR/EDR is newly-introduced.

In the Bluetooth v.4.0, a communication device (single mode device) which supports only LE and a communication device (dual mode device) which supports both BR/EDR and LE are assumed. In the case where two dual mode devices perform communication using BR/EDR, generally, while the initiating side performs detection/connection using BR/EDR, the receiving side waits to be detected/connected also using BR/EDR. Thus, LE is not utilized, and the benefit thereof, such as power saving, may not be accomplished.

On the other hand, in the Bluetooth or the like, the kind of application is set in dependency upon kind of data subjected to transmission/reception, and therefore, quantity of data subjected to transmission/reception can be expected from the kind of the applications. Thus, there may exist suitable communication topologies for each kind of applications when connection of communication is attempted to be performed or is being performed. However, there seems to be no communication device capable of setting a communication topology in dependency upon the kind of applications.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 illustrates a communication system according to an embodiment.

FIG. 2 illustrates an internal configuration of a communication device A in the embodiment.

FIG. 3 illustrates communication topologies used between the communication device A and a communication device B in the embodiment.

FIG. 4 illustrates a state where “BR/EDR” is selected.

FIG. 5 illustrates a state where “BR/EDR+LE” is selected.

FIG. 6 illustrates a state where “LE” is selected.

FIGS. 7 and 8 illustrate communication topology mapping tables, respectively.

FIGS. 9 and 10 illustrate process flows in the embodiment, respectively.

### DETAILED DESCRIPTION

One embodiment provides a communication device including: a communicator configured to communicate with another communication device through at least one of a first communication topology and a second communication topology; a processor configured to execute an application which involves a communication with the another communication device; a communication topology determiner configured to determine a communication topology between the first communication topology and the second communication topology based on at least a kind of the application; a software determiner configured to determine a control software between a first control software which supports both of the first and second communication topologies and a second control software which supports only the second communication topology, the software determiner selecting the second communication topology when the communication topology determiner determines the second communication topology; and a communication controller configured to control the communicator using the determined control software to establish the communication with the another communication device through the determined communication topology.

The software determiner may be configured to select the second communication topology everytime the communication topology determiner determines the second communication topology.

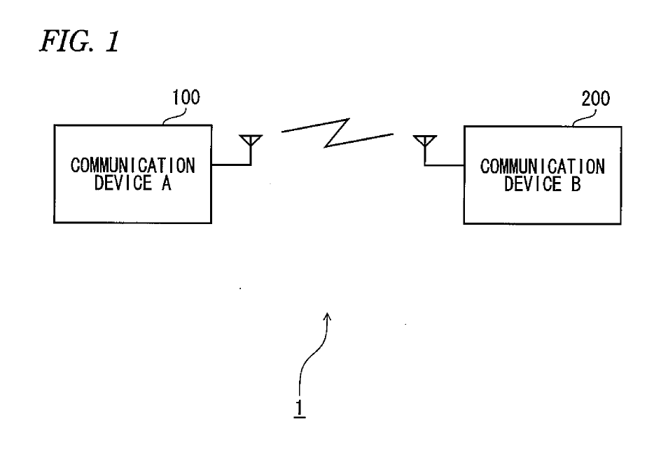

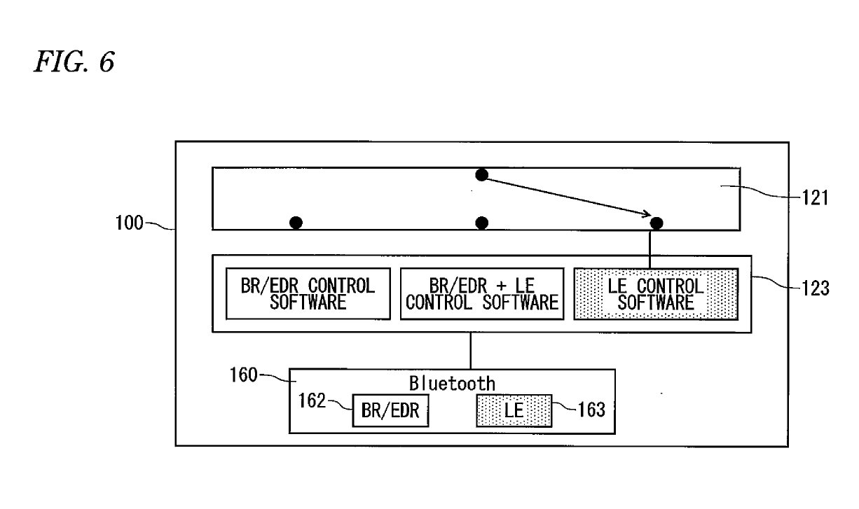

A wireless communication device and a wireless communication connection control method, etc. according to the embodiment will now be described with reference to FIGS. 1 to 10.

FIG. 1 illustrates a communication system 1 in the embodiment. The communication system 1 includes a communication device A 100 and a communication device B 200.

The communication device A 100 and the communication device B 200 performs wireless communication; in this embodiment, are assumed to perform communication by, e.g., Bluetooth. As examples of the communication device A 100 and the communication device B 200, there may be enumerated, various electronic devices, e.g., PC (Personal Computer), mobile telephone, slate-PC, mobile device such as a tablet device or a personal digital assistant (PDA), etc., and/or DTV (Digital Television), etc.

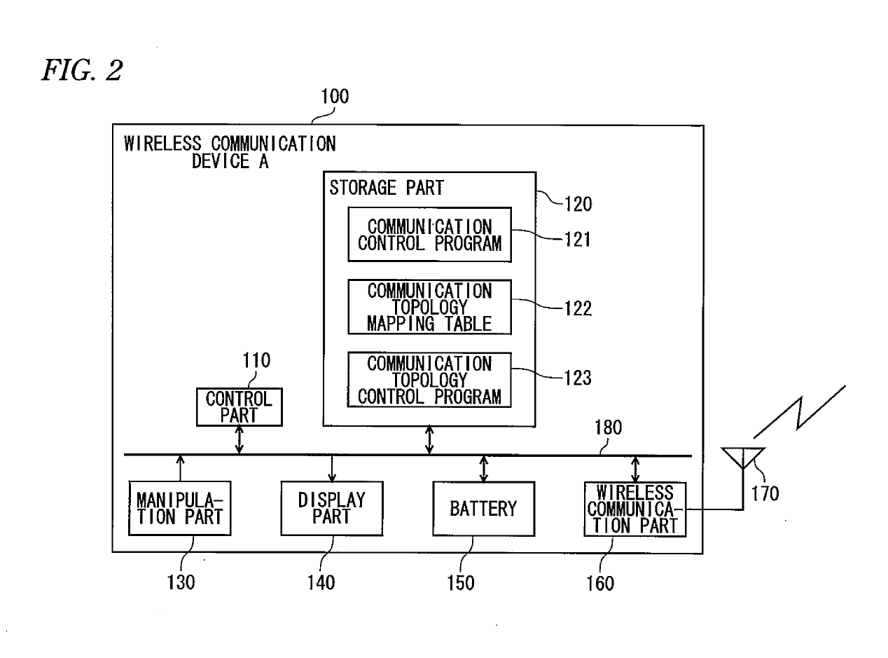

FIG. 2 illustrates an internal configuration of the communication device A 100 (wireless communication device) in this embodiment.

The communication device A 100 includes a control part 110, a storage part 120, a manipulation part 130, a display part 140, a battery 150, a communication part 160, an antenna 170 and a bus 180.

The control part 110 is, e.g., CPU (Central Processing Unit) for controlling the entirety of the communication device A 100, and executes predetermined process steps as an operation control module in accordance with programs stored in the storage part 120.

The storage part 120 is, e.g., a semiconductor memory device, and stores various programs executed by the control part 110, various information necessary for predetermined process steps and/or various kinds of data files, etc. (storage module). Moreover, the storage part 120 stores communication control program 121 serving as communication switching module, communication topology mapping table 122, and communication topology control program 123 serving as wireless communication controller. The control part 110 executes the communication control program 121 and the communication topology control program 123 to perform predetermined process steps to make reference to the communication topology mapping table 122 at this time. These process steps will be described later.

The manipulation part 130 is a manipulation input part for allowing user to input each manipulation to the communication device A 100, such as, for example, keyboard or touch panel, etc., and the manipulation part 130 provides each manipulation input from user to the communication device A 100 as a predetermined electric signal. While the keyboard and/or the touch panel, etc. are enumerated as examples in this embodiment, the present invention is not limited to these components, but may include, e.g., a signal receiving part, etc. from a remote controller of the external for allowing user to perform manipulation inputs.

The display part 140 is a display device, e.g., a liquid crystal display or a self-light emitting type display, etc., and displays images.

The battery 150 is, e.g., a storage battery, and stores power. The communication device A 100 is driven by the battery 150.

The wireless communication part 160 performs transmission/reception of radio waves by using the antenna 170, and performs wireless communication such as transmission/reception, etc. of data to and from any other communication device (e.g., communication device B 200) as a communicator.

The bus 180 connects respective components connected in the communication device A 100 so that they can respectively communicate with each other.

In this embodiment, the communication device A 100 and the communication device B 200 performs wireless communication therebetween. In this embodiment, the communication device B 200 is assumed to have the internal configuration similar to that of the communication device A 100, and the description of the internal configuration is omitted. However, this implementation is an illustration in this embodiment as a matter of course, but is not limited to such implementation. Namely, the communication device B 200 may not have the internal configuration similar to that of the communication device A 100, but may perform wireless communication with the communication device A 100.

In this embodiment, the communication device A 100 and the communication device B 200 performs wireless communication based on the Bluetooth. This implementation is illustrated in this embodiment, but is not limited to such implementation, and may therefore perform communication by any other communication standard.

In the Bluetooth, a communication topology (communication specification) is added through the version-up. In the Bluetooth v.3.0+HS, in addition to the communication topology of BR (Basic Rate)/EDR (Enhanced Data Rate) which was already defined in the Bluetooth v.2.0+EDR, AMP (Alternate MAC/PHY) being capable of performing higher speed communication but having larger power consumption as compared to BR/EDR was introduced. Moreover, in the Bluetooth v.4.0, the communication topology of LE (Low Energy) having lower communication speed but being capable of suppressing power consumption as compared to BR/EDR is introduced. In the Bluetooth, while the functions and the procedure for interoperability are specified in detail, the other aspects are specified only in terms of framework and are opened for the various implementations. And, no procedure is specified for switching of the communication topology.

The communication device A 100 internally automatically starts communication with the communication device B 200 based on user manipulation from the manipulation part 130 or in accordance with the operation control module. At this time, the control part 110 executes communication control program 121 stored in the storage part 120 to control this communication. The wireless communication part 160 performs wireless communication based on communication control of the control part 110. Alternatively, in the case where wireless connection request is received from an opponent device in a manner opposite thereto, this wireless communication device and any other wireless communication device are connected in accordance with a method compatible with the Bluetooth by using the wireless communication part 160 controlled by the wireless communication controller so that there results a state where transmission/reception of data can be bidirectionally performed between this device and the opponent device.

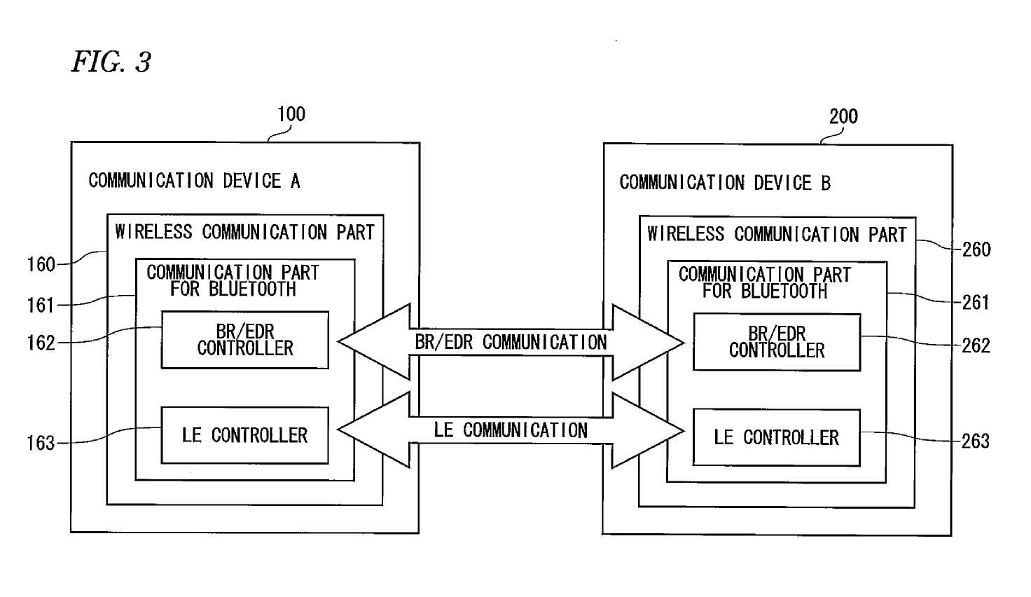

The fundamental components have been described above. Communication topologies will now be described with reference to FIG. 3.

FIG. 3 illustrates communication topologies used between the communication device A 100 and the communication device B 200 in this embodiment.

The wireless communication part 160 of the communication device A 100 includes a communication part 161 for the Bluetooth.

The communication part 161 performs communication in accordance with the Bluetooth, and includes a BR/EDR controller 162 and a LE controller 163. Namely, the communication device A 100 is the so-called dual mode device which is adapted to both support BR/EDR and LE.

The BR/EDR controller 162 is a communication controller operative in accordance with a communication topology of BR (Basic Rate) and EDR (Enhanced Data Rate) determined by the Bluetooth v.2.0+EDR.

The LE controller 163 is a communication controller operative in accordance with a communication topology of LE (Low Energy) determined by Bluetooth v.4.0.

The communication device B 200 also has a wireless communication part 260 similar to the wireless communication part 160 of the communication device A 100, and the wireless communication part 260 has components 261, 262, 263 similar to the components 161, 162, 163 of the wireless communication part 160. The communication device A 100 and the communication device B 200 can perform a communication through the Bluetooth in accordance with the communication topology of BR/EDR, LE (dual mode device).

In this embodiment, the communication device A 100 and the communication device B 200 perform communication while selecting a communication topology. In the following explanation, it is assumed that the communication device A 100 makes a request for connection to the communication device B 200.

For example, when a new logical connection request takes place, the control part 110 executes the communication control program 121 to control communication with respect to the logical connection request as the communication controller. At this time, the control part 110 further executes the communication topology control program 123 to discriminate the kind of the logical connection request of a new logical connection request. Further, the control part 110 determines a communication topology corresponding to the kind of the logical connection of this new logical connection request as the communication topology determiner with reference to the communication topology mapping table 122.

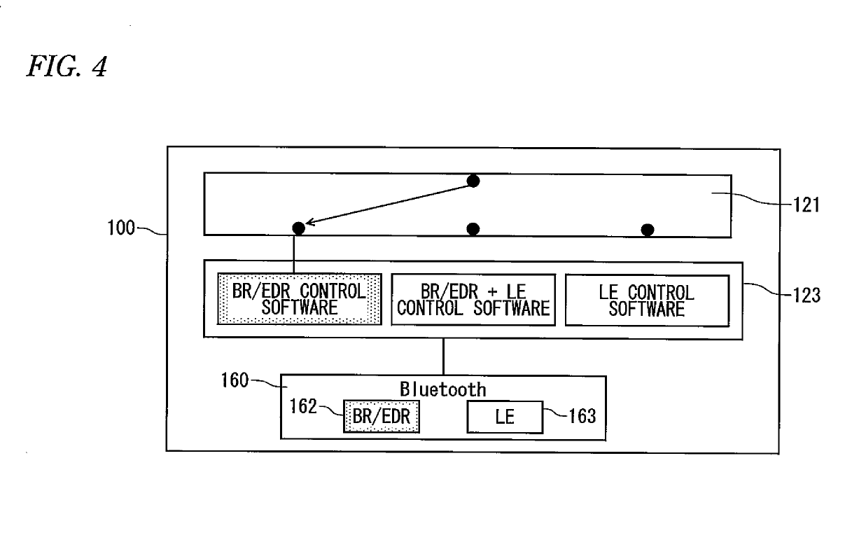

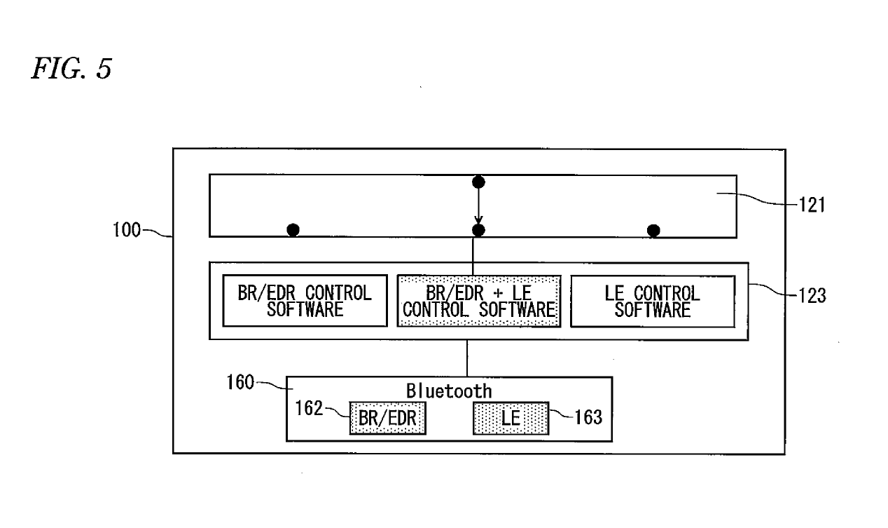

Namely, in this embodiment, the wireless communication device (communication device A 100) is provided with a switching module (communication control program 121; communication controller) to perform a control thereof to employ such a configuration to selectively and dynamically switch control software (protocol and profile) of the wireless communication controller (communication topology control program 123; communicator) to thereby implement control operations of a BR/EDR controller 162 and a LE controller 163 within the wireless communication part 160 in correspondence therewith to allow respective controllers to be respectively operated as dual mode/single mode devices (FIGS. 4, 5 and 6). For example, in FIG. 5, the controllers are used in the dual mode.

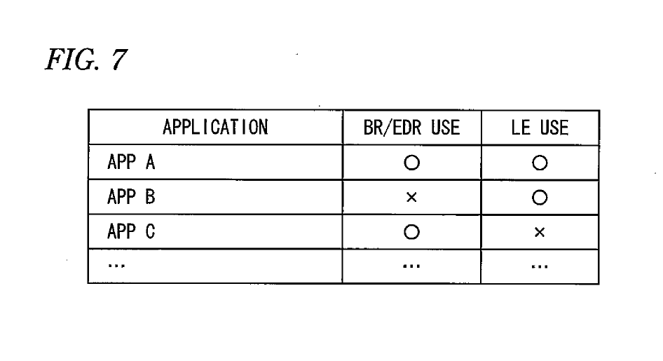

For example, the mode switching can be explicitly made by using the manipulation part 130 by user. Alternatively, in another example, as shown in FIG. 7, the relationship may be prepared with respect to the kind of applications as the communication topology mapping table 122 (to constitute the communication topology determiner) to thereby permit switching of wireless communication control software corresponding when the concerned application is executed. For example, in the case where the APP (application) A is used by user designation, this application A may be used in the dual mode 1, and may be designated by either use of BR/EDR or use of LE. In addition, for example, in the case where APP (application) B is automatically used in FIG. 7, this application B may be used by use of LE.

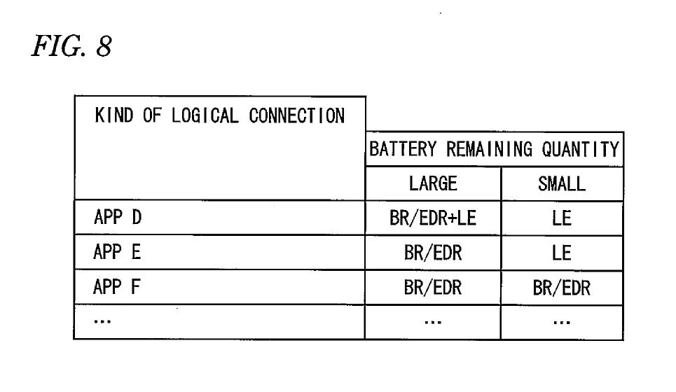

As another example, as shown in FIG. 8, in the case of a profile operable by both BR/EDR and LE, the power state may be represented in the communication topology mapping table 122 to thereby switch the mode in accordance with the battery remaining quantity. For example, in the case where the APP (application) D is used when the battery remaining quantity is large, this application D may be used in the dual mode.

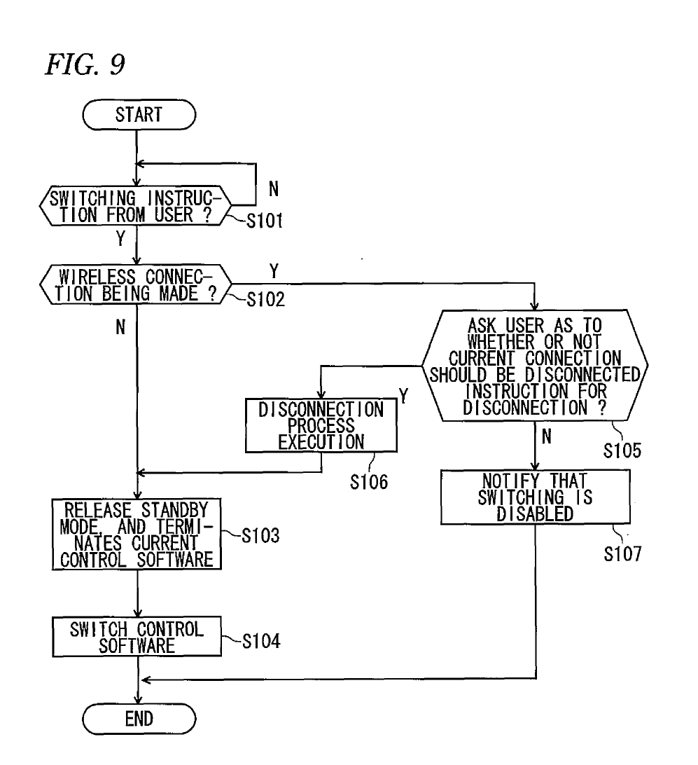

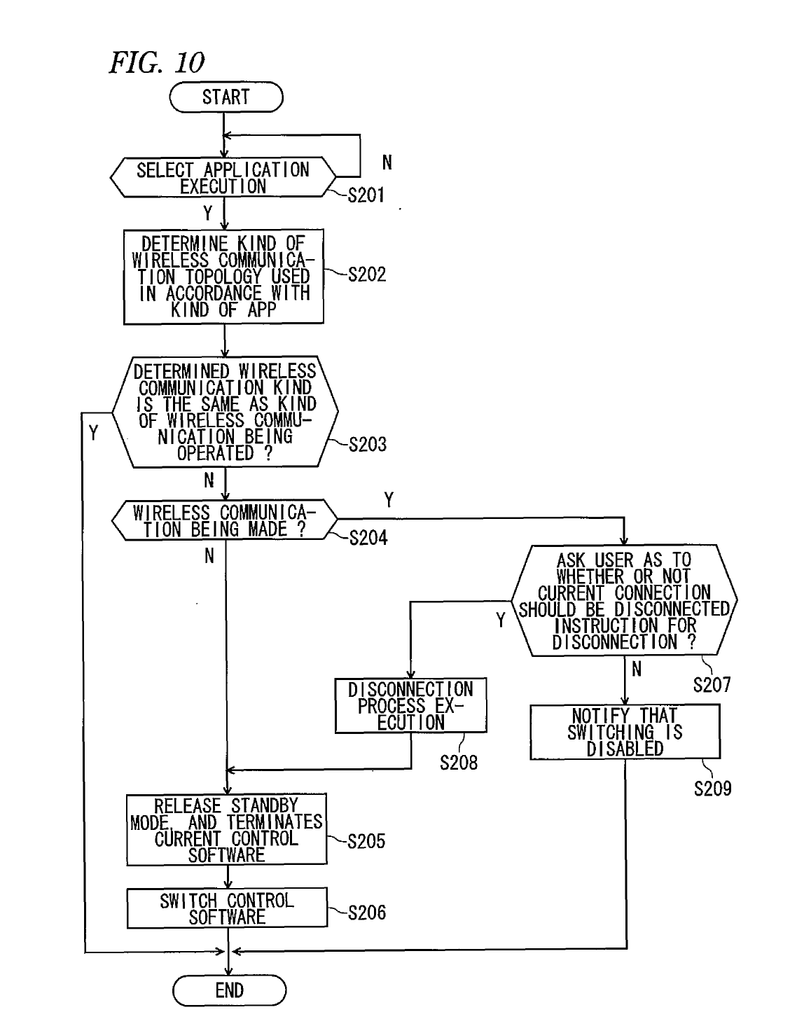

FIGS. 9 and 10 illustrate the process flows in the embodiment. In the example of FIG. 9, user is required to be conscious of the physical layer. On the other hand, in the example of FIG. 10, user can automatically handle the physical layer without being conscious of it.

FIG. 9 illustrates a process flow in the case where user explicitly designates mode switching by the manipulation part 130 of the wireless communication device (communication device A 100). FIG. 10 illustrates, based on FIG. 9, a process flow in the case where user selects an application to be executed instead of explicitly designating the mode switching.

Explanation will now be first given with reference to FIG. 9.

S101: Waits for mode switching instruction by user. In the case where such an instruction is given, process proceeds to step (S102).

S102: Determines whether or not communication connection is being made, whereby when the communication connection has been disconnected, process proceeds to step (S103), while when the communication connection is being made, process proceeds to step (S105).

S103: In the case where the communication connection is not being made (in the case of “No” in S102), shifts from the connectable mode to the non-connectable mode, and terminates the wireless connection control software which is currently being used.

S104: Switches the wireless communication control software into a control software determined in the step (S101) to execute initializing operation.

S105: In the case where the communication connection is being made (in the case of “Yes” in S102), notifies the user of the fact that “there is already a communication connection being made”, and asks the user as to whether or not the current communication connection should be disconnected. When the user allows to disconnect the current communication connection, the process proceeds to step (S106), while when the user rejects to disconnect, process proceeds to step (S107).

S106: Disconnects the current wireless communication connection. Then, the process proceeds to the step (S103).

S107: Notifies user that switching is disabled. Then, the process ends.

Explanation will now be described with reference to FIG. 10.

S201: Waits for an instruction to execute application by user. When such an instruction is given, process proceeds to step (S202).

S202: Determines the kind of a corresponding wireless communication topology from the application instructed in the step (S201) and a mapping table between the kind of APP and the kind of the wireless communication topology (FIGS. 7 and 8) to proceed to step (S203).

S203: Determines whether or not the wireless communication topology newly determined in the step (S202) is the same as the kind of the wireless communication topology being operated, whereby when the both topologies are the same, nothing is made to end this process step. On the other hand, when the both topologies are different from each other, process proceeds to step (S204).

S204: Determines whether or not the wireless connection is being made, whereby when the communication connection has been disconnected, process proceeds to step (S205), while when the wireless connection is being made, process proceeds to step (S207).

S205: In the case where the communication connection is not being made (in the case of “No” in S204), shifts from the connectable mode to the non-connectable mode, and terminates the wireless connection control software which is currently being used.

S206: Switches the wireless communication control software into a control software determined in the step (S202) to execute initializing operation.

S207: In the case where the communication connection is being made (in the case of “Yes” in S204), notifies the user of the fact that “there is already a communication connection being made”, and asks the user as to whether or not the current communication connection should be disconnected. When the user allows to disconnect the current communication connection, the process proceeds to step (S208), while when the user rejects to disconnect, process proceeds to step (S209).

S208: Disconnects the current wireless communication connection. Then the process proceeds to the step (S205).

S209: Notifies user that switching is not disabled. Then, the process ends.

As described above, in the Bluetooth v.4.0, LE (Low Energy) is defined as the wireless communication topology so that long time drive can be performed by a coin cell.

As a result, in the Bluetooth v.4.0, a device which supports only the previously-defined communication topology of BR/EDR, a single mode device which supports only the newly-defined communication topology of LE, and a dual mode device which supports both the communication topologies of BR/EDR and LE are assumed.

On the other hand, according to the Bluetooth v.4.0, the specifications of the protocol operations are different from each other in these three kinds of devices. Moreover, available profiles are also different from each other.

For example, when two of the dual mode devices are connected to each other, a usable wireless communication topology is limited to the BR/EDR. That is, the LE using the physical layer for low energy communication cannot be used. Further, a profile which is executable only on the LE link cannot be used.

According to the embodiment, in a dual mode device (it may also be referred to as a device having a “dual mode chip”) which supports both of the communication topologies of BR/EDR and LE defined in the Bluetooth v.4.0, the control software (protocol and profile) of the host side is selectively and dynamically switched. Thus, such dual mode device can be selectively operated as the dual mode device or as the single mode device. Therefore, when two dual mode devices (or two devices each having a dual mode chip) are connected to each other, power can be saved by using the physical layer for low energy communication, and the user can be allowed to use the profile executable only on the LE link.

That is, according to the embodiment, the control software (protocol and profile) of the host side is selectively and dynamically switched to thereby allow the device to selectively operate as dual mode/single mode devices. Specifically, the device may be caused to behave as if the single mode device serves.

The dual mode device (the device having the “dual mode chip”) can be widely applied. For example, although the data transmission from the peripheral device such as a body temperature meter to PC was formerly assumed, the data transmission from PC or smart-phone to a different PC, an old-type mobile telephone or a wrist watch can be assumed.

According to the embodiment, mode switching can be automatically performed in executing process in dependency upon kind of applications (profiles). On the other hand, the user is permitted to explicitly perform mode switching. Further, in the case of a profile operable in both BR/EDR and LE, mode switching may be performed in accordance with the battery remaining quantity etc.

Although the embodiment has been exemplified, it may be variously modified within the scope of the present invention. For example, one or several components may be omitted from the embodiment.

1. A communication device comprising:
a communicator configured to communicate with another communication device through at least one of a first communication topology and a second communication topology;
a processor configured to execute an application which involves a communication with the another communication device;
a communication topology determiner configured to determine a communication topology between the first communication topology and the second communication topology based on at least a kind of the application;
a software determiner configured to determine a control software between a first control software which supports both of the first and second communication topologies and a second control software which supports only the second communication topology, the software determiner selecting the second communication topology when the communication topology determiner determines the second communication topology; and
a communication controller configured to control the communicator using the determined control software to establish the communication with the another communication device through the determined communication topology.

2. The communication device of claim 1, further comprising:
a storage module configured to store a communication topology mapping table that correlates the applications with the communication topologies,
wherein the communication topology determiner is configured to determine the communication topology based on the communication topology mapping table.

3. The communication device of claim 1,
wherein the communication topology determiner is configured to determine the communication topology based on a power supply state of the communication device and the kind of the application.

4. The communication device of claim 3, further comprising:
a storage module configured to store a communication topology mapping table that correlates the power supply state and the applications with the communication topologies,
wherein the communication topology determiner is configured to determine the communication topology based on the communication topology mapping table.

5. The communication device of claim 1,
wherein the communication topology comprises one or more topologies specified in the Bluetooth v.4.0.

6. A non-transitory computer-readable medium encoded with instructions thereon, wherein the instructions are readable by a communication device in order to cause the communication device to perform operations comprising:
executing an application which involves a communication with the another communication device;
determining a communication topology between a first communication topology and a second communication topology based on at least a kind of the application;
determining a control software between a first control software which supports both of the first and second communication topologies and a second control software which supports only the second communication topology, the step of determining selecting the second communication topology when the communication topology determiner determines the second communication topology; and
establish the communication with the another communication device through the determined communication topology by using the determined control software.

7. A communication method for a communication device, the method comprising:
executing an application which involves a communication with the another communication device;
determining a communication topology between a first communication topology and a second communication topology based on at least a kind of the application;
determining a control software between a first control software which supports both of the first and second communication topologies and a second control software which supports only the second communication topology, the step of determining selecting the second communication topology when the communication topology determiner determines the second communication topology; and
establish the communication with the another communication device through the determined communication topology by using the determined control software.
